(19) United States
(12) Patent Application Publication
(10) Pub. No.: US 2016/0167356 A1
(43) Pub. Date: Jun. 16, 2016

(54) METHOD FOR PRODUCING A LAMINATED PANEL

(71) Applicant: GM GLOBAL TECHNOLOGY OPERATIONS LLC, Detroit, MI (US)

(72) Inventor: Walter RIETHER, Nauheim (DE)

(73) Assignee: GM GLOBAL TECHNOLOGY OPERATIONS LLC, Detroit, MI (US)

(21) Appl. No.: 14/939,144

(22) Filed: Nov. 12, 2015

(30) Foreign Application Priority Data
Nov. 15, 2014 (DE) 102014016930.8

(51) Int. Cl. B32B 37/14; B32B 37/10; B32B 37/06

(52) U.S. Cl. CPC B32B 37/142; B32B 37/06; B32B 37/10; B32B 2605/08

(57) ABSTRACT

The invention pertains to a method for manufacturing a sandwich sheet (15) with the steps of: making available an unprocessed sandwich sheet (9) with a first metal sheet (10), a second metal sheet (11) and a plastic layer (12), in which the plastic layer (12) is arranged between the two metal sheets (10, 11), locally heating the metal sheet (10, 11) and locally heating the plastic layer (12) in a local connecting region (14), deforming the metal sheet (10, 11) in the local connecting region (14) such that the heated plastic layer (12) is displaced between the two metal sheets (10, 11) in the local connecting region (14) and the two metal sheets (10, 11) are contacted in the local connecting region (14), and welding together the first and the second metal sheet (10, 11) in the local connecting region (14), in which the two metal sheets (10, 11) were contacted, such that the two metal sheets (10, 11) are connected to one another by means of a welded joint (16) in the local connecting region (14), wherein a tool (17) is placed onto the outer side of the metal sheet (10, 11) in the local connecting region (14) and the tool (17) is moved relative to the metal sheet (10, 11) on the outer side of the metal sheet (10, 11) in the local connecting region (14) such that the metal sheet (10, 11) is heated in the local connecting region (14) due to the friction between the tool (17) and the metal sheet (10, 11) and the plastic layer (12) is heated in the local connecting region (14) by the heated metal sheet (10, 11).

### CROSS REFERENCE TO RELATED APPLICATION

This application claims priority to German Patent Application No. 102014016930.8 filed Nov. 15, 2015, which is incorporated herein by reference in its entirety.

### TECHNICAL FIELD

The present invention pertains to a method for manufacturing a laminated panel and to a method for manufacturing a motor vehicle.

### BACKGROUND

Motor vehicles in the form of a passenger cars feature a car body and a propulsion engine. The car body forms the supporting component and therefore requires a high rigidity. In addition to pure steel sheets, laminated panels are sometimes also used as parts of the car body. Laminated panels comprise two outer metal sheets, typically steel sheets, between which a plastic layer is arranged. Laminated panels provide the advantage of a lower weight than pure steel sheets. A sufficient rigidity of such a laminated panel can only be achieved if the two metal sheets are welded to one another at certain points in local connecting regions. In order to produce such a welded joint, it is necessary to locally heat one metal sheet on its outer side such that the plastic layer is also heated to a softening temperature in excess of 200° C. in the local connecting region, wherein this causes the plastic layer to soften and become viscous such that it can be displaced due to a local deformation of a metal sheet. The two metal sheets can only be welded to one another after they have been directly contacted at the respective welding points in the local connecting region. The two metal sheets can be welded to another component of metal in this local connecting region, in which the two metal sheets lie directly on top of one another.

### SUMMARY

The objective of the present invention therefore can be seen in making available a method for manufacturing a laminated panel and a method for manufacturing a motor vehicle, in which a welded joint between two steel sheets of an unprocessed laminated panel can be reliably produced with little technical effort.

This objective is attained with a method for manufacturing a laminated panel with the following steps: making available an unprocessed laminated panel with a first metal sheet, a second metal sheet and a plastic layer, in which the plastic layer is arranged between the two metal sheets, locally heating the metal sheet and locally heating the plastic layer in a local connecting region, deforming the metal sheet in the local connecting region such that the heated plastic layer is displaced between the two metal sheets in the local connecting region and the two metal sheets are contacted in the local connecting region, and welding together the first and the second metal sheet in the local connecting region, in which the two metal sheets were contacted, such that the two metal sheets are connected to one another by means of a welded joint in the local connecting region, wherein a tool is placed onto the outer side of the metal sheet in the local connecting region and the tool is moved relative to the metal sheet on the outer side thereof in the local connecting region such that the metal sheet is heated in the local connecting region due to the friction between the tool and the metal sheet and the plastic layer is heated in the local connecting region by the heated metal sheet. The tool rests on the metal sheet during its motion relative to the metal sheet. In this way, the metal sheet and therefore also the plastic layer can be reliably heated with little technical effort.

In another embodiment, the tool carries out a rotatory motion and/or translatory motion on the outer side of the metal sheet in order to generate friction between the tool and the metal sheet, wherein the rotational axis of the rotatory motion is in the local connecting region aligned, in particular, essentially perpendicular to an outer side of the metal sheet, i.e. with a deviation of less than 30°, 20°, 100 or 50. In this way, the tool can be moved relative to the metal sheet, but the tool nevertheless does not change the position of its outer surfaces if it has a rotationally symmetrical design. In practical applications, the motion therefore can be realized in a particularly unproblematic fashion on an assembly line. Alternatively, the tool could also carry out a translatory motion relative to the metal sheet.

In another embodiment, the tool is realized in the form of a forming tool and a compressive force is exerted upon the outer side of the metal sheet in the local connecting region by means of the forming tool such that the metal sheet is deformed in the local connecting region and the heated plastic layer is displaced between the two metal sheets in the local connecting region in order to contact the two metal sheets, in particular directly, in the local connecting region and/or the tool is lifted off the metal sheet after it was placed thereon and moved relative thereto, as well as after the deformation of the metal sheet and after the displacement of the plastic layer. The tool therefore serves for heating the metal sheet by means of friction, as well as for deforming the metal sheet and for displacing the plastic layer. These processing steps therefore can be advantageously carried out with the tool in the form of a forming tool.

The compressive force for deforming the metal sheet is advantageously exerted upon the metal sheet by the forming tool during and/or after the motion of the tool relative to the metal sheet in the local connecting region. If the compressive force for deforming the metal sheet is exerted during the motion of the tool, particularly its rotatory motion, the metal sheet can thereby be additionally heated by means of friction during its deformation.

In a supplementary embodiment, the two metal sheets are welded to one another in the local connecting region by means of electric resistance welding, particularly resistance spot welding or resistance projection welding. Resistance spot welding makes it possible to weld the two metal sheets to one another at certain points in a particularly fast and reliable fashion.

In another variation, a first electrode is placed onto the first metal sheet in the local connecting region and a second electrode is placed onto the second metal sheet in the local connecting region before the resistance welding operation is carried out and a current is subsequently conducted through the first and the second electrode and through the first and the second metal sheet that are locally contacted in the local connecting region. Due to the local contact between the two metal sheets, a current for the resistance spot welding operation can be conducted through the two metal sheets to be welded together.

In another embodiment, the metal sheet and the plastic layer are heated, the metal sheet is deformed, the plastic layer is displaced and the first and the second metal sheet are welded to one another in several local connecting regions, preferably in succession, in order to manufacture a laminated panel, in which the first and the second metal sheet are connected to one another by means of welded joints in several local connecting regions. In the manufacture of larger laminated panels with a large surface area, it is generally necessary to connect the two metal sheets to one another with several welded joints, e.g. more than 5, 10, 20 or 30 welded joints, in order to achieve a sufficient rigidity.

In another embodiment, the tool and/or the first and/or the second electrode are actuated and/or moved by means of a robot.

In another embodiment, the tool is initially actuated and/or moved by means of a first robot and the first and/or second electrode is subsequently actuated and/or moved by means of a second robot in order to respectively produce a welded joint. In this case, the first robot heats and deforms the metal sheet and the second robot carries out the welding operation with the electrodes.

In a supplementary embodiment, the tool and the first and/or second electrode are actuated and/or moved, in particular, with only one robot in order to respectively produce a welded joint. In this case, a single robot heats and deforms the metal sheet and carries out the welding operation with the electrodes.

The tool is advantageously composed of a first and a second tool part and the first and the second tool part are moved apart from one another after the placement onto the metal sheet and after the motion of the tool on the outer side of the metal sheet while and/or after the tool is lifted off the metal sheet, wherein an electrode is moved toward the metal sheet through the space between the two tool parts and placed onto the metal sheet. Consequently, one robot, in which the tool and the electrodes are arranged on one working element, heats and deforms the metal sheet and carries out the welding operation with the electrodes.

In a supplementary embodiment, the unprocessed laminated panel is made available with a first and/or second metal sheet of steel or aluminum and/or with a plastic layer of polyethylene (PE) or polyamide (PA).

The unprocessed laminated panel is advantageously made available in such a way that the first and the second metal sheet are connected to the plastic layer in a firmly bonded fashion.

In another exemplary embodiment, the plastic layer is heated up to a softening temperature in the local connecting region, in particular, with only the heat generated by the friction between the tool and the metal sheet such that the plastic layer can only be displaced and/or becomes free-flowing and/or viscous, in particular, in the local connecting region.

The invention furthermore discloses a method for manufacturing a motor vehicle with the following steps: making available at least one unprocessed laminated panel, making available a propulsion engine, particularly an electric motor and/or an internal combustion engine, making available wheels, making available a component of metal and connecting the at least one laminated panel, the propulsion engine, the wheels and the component into a motor vehicle, wherein at least one laminated panel is manufactured of the at least one unprocessed laminated panel with a method described in this application for property rights and the unprocessed laminated panel or the laminated panel is respectively connected to the component by means of resistance welding.

In another embodiment, the respective unprocessed laminated panel or laminated panel is connected to the component by means of resistance welding and/or a welded joint is produced by means of resistance welding between the respective unprocessed laminated panel or laminated panel and the component, particularly between a metal sheet of the respective unprocessed laminated panel or laminated panel and the component, with the method described in this application for property rights, particularly during the production of the welded joint between the two metal sheets, in the manufacture of the at least one laminated panel of the at least one unprocessed laminated panel.

It is advantageous that two welded joints are respectively produced by means of resistance welding between the two metal sheets and between one metal sheet of the respective unprocessed laminated panel or laminated panel and the component in each local connecting region during the resistance welding operation.

In another embodiment, a first electrode is placed onto the first metal sheet in the local connecting region before the resistance welding operation is carried out, the second metal sheet is placed onto a first outer side of the component in the local connecting region and a second electrode is placed onto the component on a second outer side in the local connecting region, wherein a current is subsequently conducted through the first and the second electrode, through the first and the second metal sheet and through the component that are locally contacted to one another in the local connecting region. The component may also be placed onto the unprocessed laminated panel before the metal sheet is frictionally heated by means of the tool and, for example, also temporarily act as a holding part that counteracts the compressive forces exerted upon the unprocessed laminated panel by the tool.

In a supplementary embodiment, the metal sheet and the plastic layer are heated, the metal sheet is deformed, the plastic layer is displaced and the first and the second metal sheet, as well as the component, are welded to one another in several local connecting regions, preferably in succession, in order to manufacture a laminated panel, in which the first and the second metal sheet are connected to one another by means of welded joints in several local connecting regions and the laminated panel is connected to the component by means of welded joints in several local connecting regions.

The at least one laminated panel and/or the component preferably form part of the body of the motor vehicle or another component of the motor vehicle such as, for example, an oil pan of an internal combustion engine.

In a supplementary variation, the component is at least partially, in particular entirely, made of metal, preferably of steel or aluminum.

The component advantageously consists of a metal sheet or a carrier or a support or an engine block.

In another embodiment, the component forms part of the vehicle body.

In a supplementary embodiment, the laminated panel is manufactured in such a way that the sum of the surface areas of the welded joints is significantly smaller than the surface area of the laminated panel, preferably smaller than 20%, 10%, 5%, 2% or 1% of the surface area of the laminated panel. The welded joints therefore are only locally produced at certain points over a small portion of the respective surface area of the laminated panel or the metal sheets.

The invention furthermore comprises a computer program with program code means that are stored on a machine-readable storage medium in order to carry out a method described in this application for property rights when the computer program is executed on a computer or a corresponding processing unit.

Another aspect of the invention concerns a computer program product with program code means that are stored on a machine-readable storage medium in order to carry out a method described in this application for property rights when the computer program is executed on a computer or a corresponding processing unit.

### BRIEF DESCRIPTION OF THE DRAWINGS

The present invention will hereinafter be described in conjunction with the following drawing figures, wherein like numerals denote like elements.

FIG. 1 shows a side view of a motor vehicle,

FIG. 2 shows a longitudinal section through an unprocessed laminated panel and a tool before the placement onto an outer side of the unprocessed laminated panel,

FIG. 3 shows a longitudinal section through the unprocessed laminated panel and the tool according to FIG. 2 after the placement onto the outer side of the unprocessed laminated panel, namely during a rotational motion of the tool and the application of a compressive force onto the outer side of the unprocessed laminated panel in an initial deformation phase of a metal sheet,

FIG. 4 shows a longitudinal section through the unprocessed laminated panel and the tool according to FIG. 2 after the placement onto the outer side of the unprocessed laminated panel, namely during a rotational motion of the tool and the application of a compressive force onto the outer side of the unprocessed laminated panel in a final deformation phase of a metal sheet,

FIG. 5 shows a longitudinal section through the laminated panel and two electrodes after the production of a spot-welded joint between two metal sheets of the laminated panel according to a first exemplary embodiment of the method,

FIG. 6 shows a longitudinal section through the laminated panel, a component and two electrodes after the respective production of a spot-welded joint between two metal sheets of the laminated panel and between one metal sheet of the laminated panel and the component according to a second exemplary embodiment of the method,

FIG. 7 shows a longitudinal section through a two-part tool and an electrode before the two tool parts are moved apart from one another,

FIG. 8 shows a longitudinal section through the two-part tool and the electrodes according to FIG. 7 after the two tool parts have been moved apart from one another and the electrode has been moved onto a not-shown outer side of the metal sheet,

FIG. 9 shows a side view of a robot, and

FIG. 10 shows a flowchart of the processing steps.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

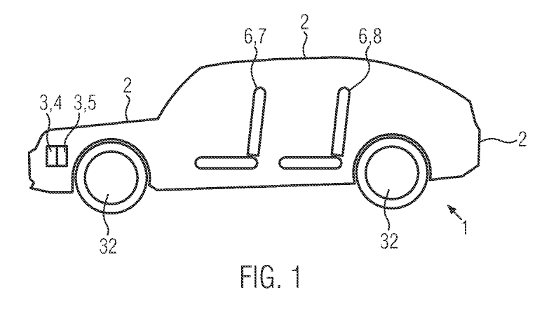

A motor vehicle 1 illustrated in FIG. 1 features wheels 32, a car body 2 that is composed of steel sheets and at least one laminated panel 15 and a propulsion engine 3 in the form of an electric motor 4 and/or an internal combustion engine 5 that is arranged within an engine compartment defined by the car body 2. Two seats 6 in the form of front seats 7 and three seats 6 in the form of back seats 8 are arranged within an interior defined by the car body 2. In this case, the back seats 8 are combined into a bench seat. The seats 6 serve for accommodating passengers. The roof section of the car body 2 is made of the laminated panel 15.

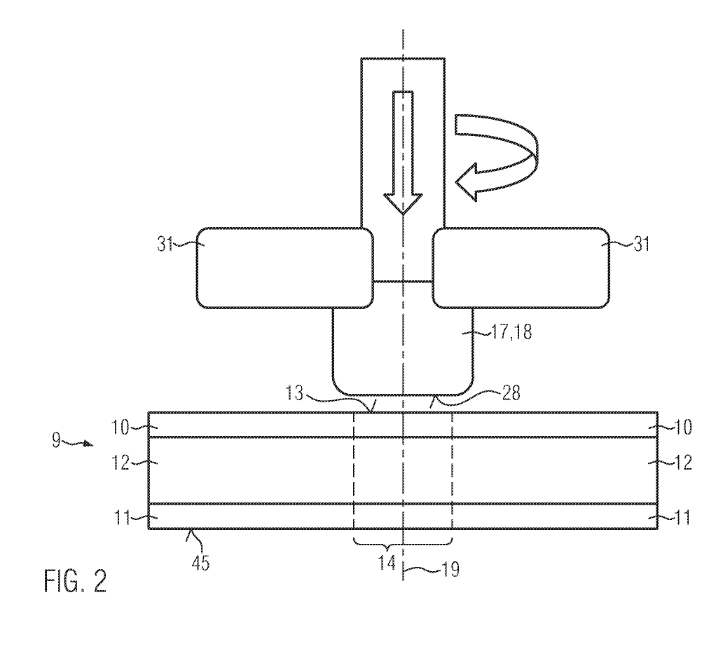

The car body 2 of the motor vehicle 1 therefore consists of steel sheets, i.e. a sheet that consists exclusively of steel or steel sheets, and of at least one laminated panel 15. The laminated panel 15 comprises a first metal sheet 10 and a second metal sheet 11 that preferably are respectively made of steel, as well as a plastic layer 12, for example, of polyethylene (PE) or polyamide (PA). The two metal sheets 10, 11 have a thickness between 0.2 and 0.4 mm and the plastic layer 12 has a thickness between 0.2 and 0.8 mm. In the manufacture of the motor vehicle 1, an unprocessed laminated panel 9 (FIG. 2) is initially made available, for example, in that a supplier delivers the unprocessed laminated panel 9 to a manufacturer of the motor vehicle 1. In the unprocessed laminated panel 9, the first and the second metal sheet 10, 11 and the plastic layer 12 are only indirectly connected to one another in a firmly bonded fashion, i.e. no direct connection exists between the metal of the two metal sheets 10, 11. This connection is insufficient for use of the unprocessed laminated panel 9 in the body 9 of the motor vehicle 1.

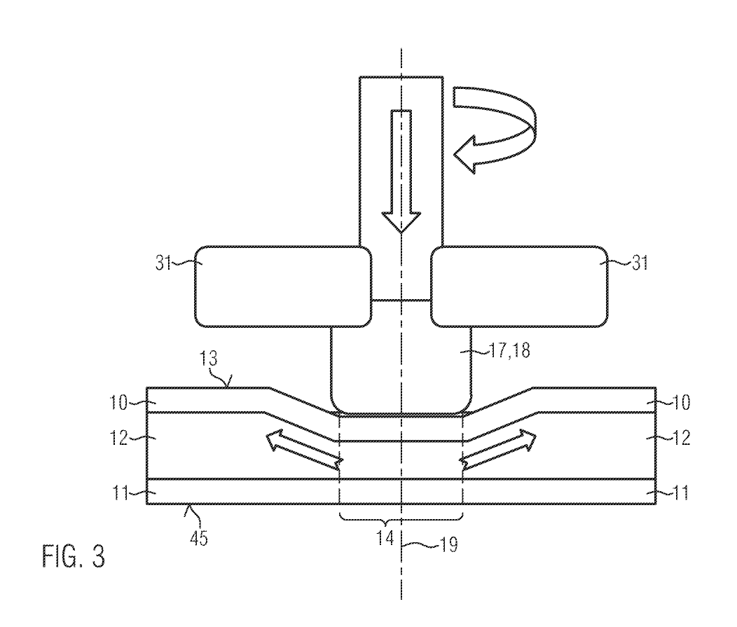

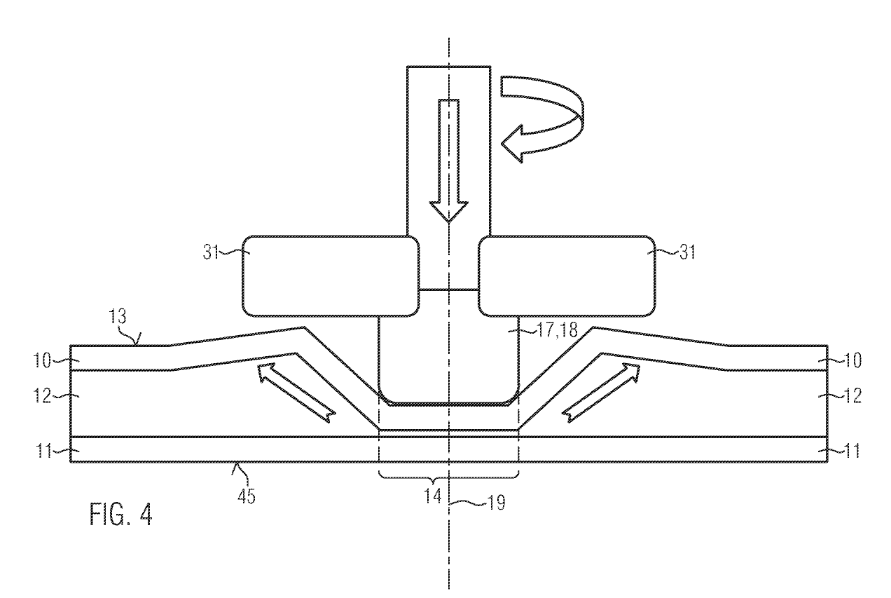

In the manufacture of the laminated panel 15 of the unprocessed laminated panel 9, a forming tool 18 in the form of a tool 17 that rotates about a rotational axis 19 is in a local connecting region 14 placed onto an outer side 13 of the first metal sheet 10 with a low compressive force with a working surface 28 of the tool 17. In this way, the working surface 28 of the tool 17 respectively carries out a rotatory motion relative to the stationary first metal sheet 10 or the unprocessed laminated panel 9 such that friction occurs between the working surface 28 and the outer side 13 of the first metal sheet 10 in the local connecting region 14. The local connecting region 14 lies on a cylindrical section of the unprocessed laminated panel 9 perpendicular to a fictitious plane defined by the unprocessed laminated panel 9. The unprocessed laminated panel 9 is plane and the rotational axis 19 is essentially aligned perpendicular to the fictitious plane defined by the unprocessed laminated panel 9. The tool 17 consists of a special plastic with low thermal conductivity such that the heat generated due to the friction between the working surface 28 and the outer side 13 of the first metal sheet 10 is only insignificantly dissipated by the tool 17 and the frictionally generated heat substantially heats the first metal sheet 13 in the local connecting region 14. Due to the thermal conduction, the substantially heated first metal sheet 10 also heats the plastic layer 12 to a temperature above 200° C., e.g. to 230° C. or 250° C., in the local connecting region 14. The plastic layer 12 begins to soften at a temperature of 200° C. such that a greater compressive force than for generating the friction is preferably exerted upon the outer side 13 of the first metal sheet 10 by means of the forming tool 18 in the form of the tool 17 once this temperature is reached in order to deform the first metal sheet 10 (FIG. 3) in the direction of the second metal sheet 11 due to the compressive force exerted by the forming tool 18 and to simultaneously displace the plastic layer 12 from the intermediate space between the first and the second metal sheet 10, 11 in the local connecting region 14 until direct contact between the first and the second metal sheet 10, 11 is produced. The tool 17 preferably continues to carry out a rotatory motion during the deformation of the first metal sheet 10. A not-shown holding tool or a component 46 rests on an outer side 45 of the second metal sheet 11 in the local connecting region 14 during the deformation of the first metal sheet 10 by means of the forming tool 18 in order to essentially prevent the unprocessed laminated panel 9 from being subjected to bending stresses. An annular stop 31 is formed on the tool 17 in order to limit the upward deformation of the first metal sheet 10 (FIG. 4).

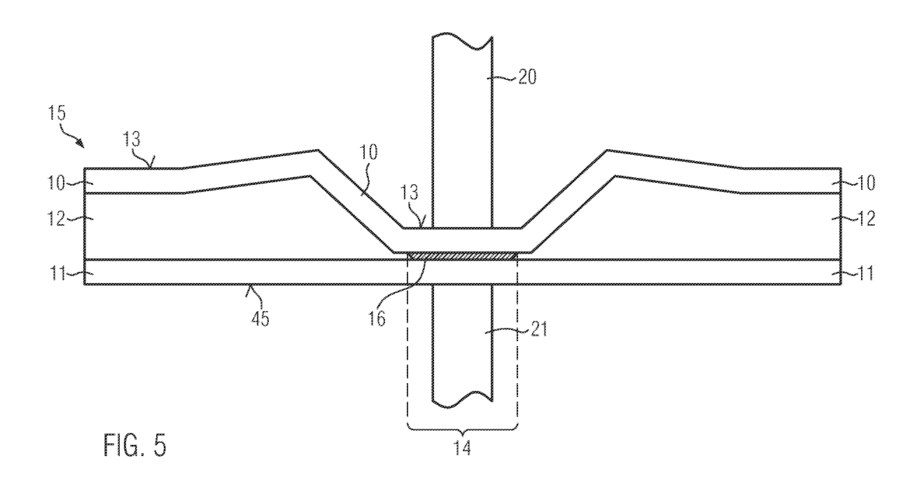

After direct contact between the first and the second metal sheet 10, 11 has been produced in the local connecting region 14, the tool 17 is lifted off the outer side 13 of the first metal sheet 10 and the tool 17 is removed from the local connecting region 14. Subsequently, a first electrode 20 is placed onto the outer side 13 of the first metal sheet 10 in the local connecting region 14 and a second electrode 21 is analogously placed onto the outer side 45 of the second metal sheet 11 (FIG. 5). An electric current is then briefly conducted through the two electrodes 20, 21 such that a welded joint 16 is produced between the steel of the first and the second metal sheet 10, 11 in the local connecting region 14 by means of resistance spot welding and the laminated panel 15 is thereby manufactured. The unprocessed laminated panel 9 has large dimensions perpendicular and parallel to the plane of projection in FIG. 2 such that several welded joints 16 are produced by repeating the above-described processing steps in order to reliably connect the two metal sheets 10, 11 to one another.

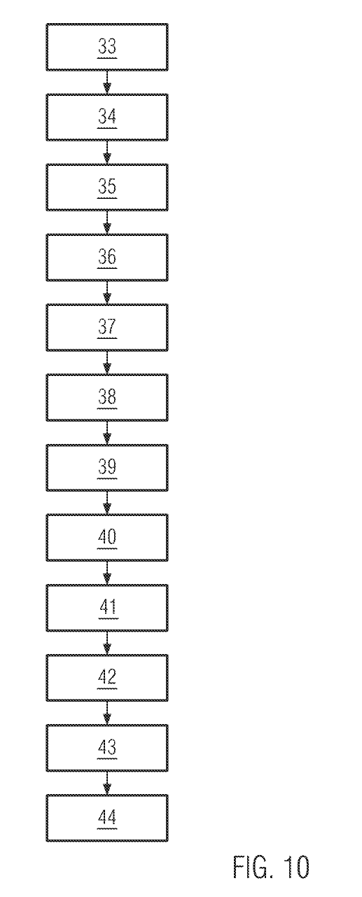

FIG. 10 shows the processing steps in the form of a flow chart. In the first exemplary embodiment of the method, the tool 17 is placed onto 34 the outer side 13 of the first metal sheet 10 with a compressive force after the tool 17 has been moved 33 to the first metal sheet 10. Subsequently, the tool 17 carries out a rotatory motion 35 such that the first metal sheets 10 and the plastic layer 12 are locally heated 36 due to the friction between the tool 17 and the first metal sheet 10. The rotatory motion 35 and the heating 36 take place simultaneously. Subsequently, a greater compressive force is preferably exerted upon the first metal sheet 10 by means of the tool 17 such that the first metal sheet 10 is deformed 37 and the plastic layer 12 is displaced 38 in the local connecting region 14. The rotatory motion 35 of the tool 17 and the heating 36 may optionally also take place during the deformation 37 and the displacement 38. Subsequently, the tool 17 is lifted off 39 the first metal sheet 10 and the electrodes 20, 21 are moved 40 to the first and the second metal sheet 10, 11, whereupon the two electrodes 20, 21 are placed onto 41 the two metal sheets 10, 11. An electric current is then conducted 42 through the electrodes 20, 21 and locally through the two metal sheets 10, 11 such that a welded joint 16 is produced by locally resistance welding 43 the two metal sheets 10, 11. The conduction 42 of a current and the resistance welding operation 43 take place simultaneously. The electrodes 20, 21 are lifted off 44 the two metal sheets 10, 11 after the resistance welding operation 43 has been completed.

A first and a second robot 22 in the form of industrial robots 22 serve for actuating and moving the tool 17 and the electrodes 20, 21. The robot 22 features several robot arms 23 that are connected to one another in an articulated fashion by means of at least one robotic joint 24 such that the robot arms 23 are freely movable in space. A working element 25 is arranged on the end of the last robot arm 23. The working element 25 of the first robot 22 comprises the tool 17, as well as a not-shown electric motor for moving the tool 17. The robot 22 therefore is able to place the tool 17 onto the outer side 13 of the first metal sheet 10 and to activate the rotatory motion of said tool, as well as to exert the required compressive force upon the first metal sheet 10 by means of the working surface 28. After the complete deformation of the first metal sheet 10, the two electrodes 20, 21 are placed onto the two metal sheets 10, 11 by means of the second robot 22. The two electrodes 20, 21 are fixed on the working element 25 of the second robot 22. Consequently, two robots 22 are required in the above-described processing steps.

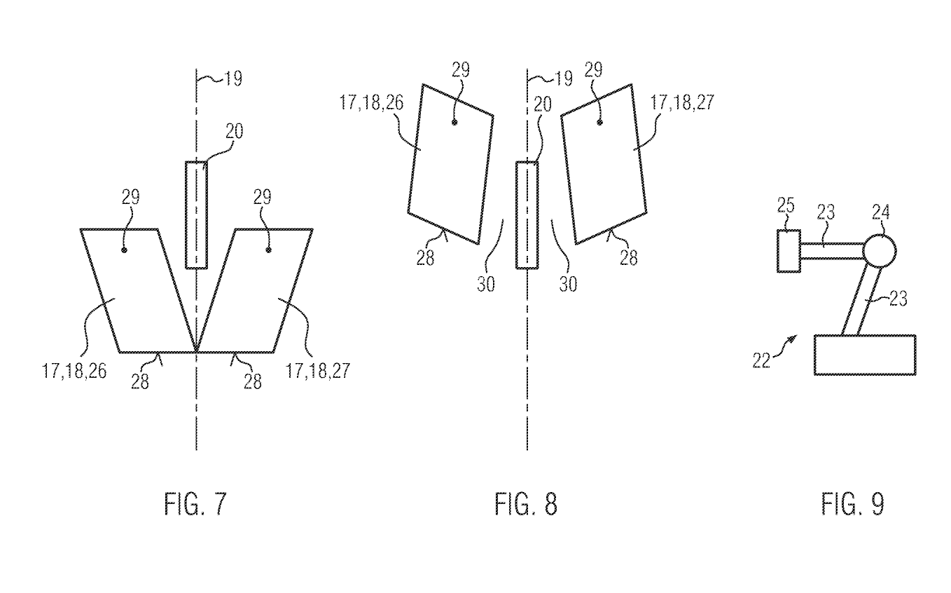

In an alternative variation for carrying out the manufacturing method, the tool 17 and the two electrodes 20, 21 may be fixed on the working element 25 of only one robot 22. In this context, only the differences between this variation and the above-described processing steps are essentially described below. The tool 17 is composed of a first tool part 26 and a second tool part 27 (FIGS. 7 and 8) and both tool parts 26, 27 can be respectively pivoted about a pivoting axis 29 by means of a not-shown servomotor. In the pivoting position of the two tool parts 26, 27 illustrated in FIG. 7, these tool parts form a coherent working surface 28 before they are placed onto the outer side 13 of the first metal sheet 10. The two tool parts 26, 27 are jointly rotatable about the rotational axis 19 in order to generate friction. After the complete deformation of the first metal sheet 10, the two tool parts 26, 27 are slightly lifted off the first metal sheet 10 and the two tool parts 26, 27 are pivoted about the pivoting axes 29 such that a space 30 (FIG. 8) is formed between the two tool parts 26, 27 and the first electrode 20 can be moved to the outer side 13 of the deformed first metal sheet 10 through this space 30. The second electrode 21, which is likewise fixed and movable on the working element 25 of the robot 22, is not illustrated in FIGS. 7 and 8. In this variation, the welded joint 16 therefore can be produced with only one robot 22.

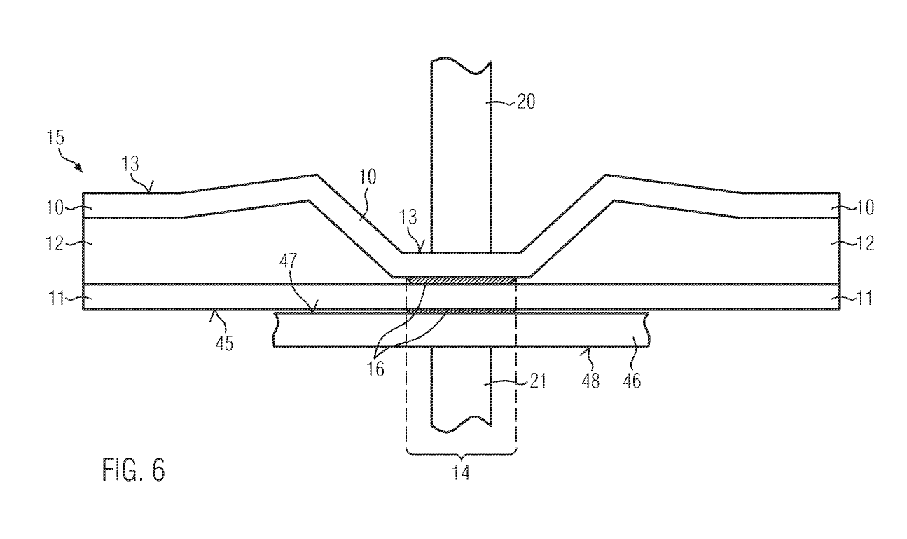

FIG. 6 shows a second exemplary embodiment of the method. In this context, only the differences between this exemplary embodiment and the above-described first exemplary embodiment are essentially described below. After directly contacting the first and the second metal sheet 10, 11 in the local connecting region 14, the tool 17 is lifted off the outer side 13 of the first metal sheet 10 and the tool 17 is removed from the local connecting region 14. A first outer side 47 of the component 46 is placed onto an outer side 45 of the second metal sheet 11 in the local connecting region 14 such that the first outer side 47 of the component 46 is in direct contact with the outer side 45 of the second metal sheet 11 in the local connecting region 14. The component 46 has a first outer side 47 and the first outer side 47 lies opposite of a second outer side 48. Subsequently, a first electrode 20 is placed onto the outer side 13 of the first metal sheet 10 in the local connecting region 14 and a second electrode 21 is placed onto the outer side 48 of the component 46 (FIG. 6). An electric current is then briefly conducted through the two electrodes 20, 21, the two metal sheets 10, 11 and the component 46 such that a first welded joint 16 is produced between the steel of the first and the second metal sheet 10, 11 in the local connecting region 14 between the two metal sheets 10, 11 and the laminated panel 15 is thereby manufactured, wherein a second welded joint 16 is simultaneously produced between the second metal sheet 11 and the component 46 such that the respective unprocessed laminated panel 9 or laminated panel 15 is also connected to the component 46. For example, the component 46 forms part of the car body 2 and consists exclusively of metal, e.g. of steel or aluminum, such that, for example, a roof region of the car body 2 consisting of the laminated panel 15 is connected to the remainder of the car body 2 in the form of the component 46.

FIG. 10 shows the processing steps in the form of a flow chart. In the second exemplary embodiment of the method, the tool 17 is placed onto 34 the outer side 13 of the first metal sheet 10 with a compressive force after the tool 17 has been moved 33 to the first metal sheet 10. Subsequently, the tool 17 carries out a rotatory motion 35 such that the first metal sheet 10, as well as the plastic layer 12, is locally heated 36 due to the friction between the tool 17 and the first metal sheet 10. The rotatory motion 35 and the heating operation 36 take place simultaneously. A greater compressive force is then preferably exerted upon the first metal sheet 10 by means of the tool 17 such that a deformation 37 of the first metal sheet 10 and a displacement 38 of the plastic layer 12 take place in the local connecting region 14. The rotatory motion 35 of the tool 17 and the heating operation 36 may optionally also take place during the deformation 37 and the displacement 38. Subsequently, the tool 17 is lifted off 39 the first metal sheet 10 and the electrodes 20, 21 are moved 40 to the first metal sheet 10 and to the component 46, wherein the two electrodes 20, 21 are then placed onto 41 the first metal sheet 10 and the component 46. The two metal sheets 10, 11 and the component 46 are then locally resistance welded 43 by conducting 42 an electric current through the electrodes 20, 21 and locally through the two metal sheets 10, 11, as well as the component 46, such that two welded joints 16 are simultaneously produced, namely between the two metal sheets 10, 11 and between the second metal sheet 11 and the component 46. The conduction 42 of a current and the resistance welding operation 43 take place simultaneously. After the completion of the resistance welding operation 43, the electrodes 20, 21 are lifted off 44 the first metal sheet 10 and the component 46.

All in all, the inventive method for manufacturing a laminated panel 15 is associated with significant advantages. The local heating of the plastic layer 12, the deformation of the metal sheet 10 and the local displacement of the plastic layer 12, as well as the application of the compressive force for deforming the metal sheet 10, are carried out with only one tool 17 and require no other heating devices or heating means such as, e.g., a flame. The manufacturing process is thereby significantly simplified, inexpensive and at the same time highly reliable. In this way, the subsequent electric resistance welding and connection to the component 46 can be realized without any difficulty.

Although at least one exemplary embodiment was described above, it should be acknowledged that a large number of variations of this exemplary embodiment exist. It should also be acknowledged that the exemplary embodiment or the exemplary embodiments are mere examples and therefore not intended to restrict the scope of protection, the applicability or feasibility or the design in any way. The preceding description provides a person skilled in the art with suitable instructions for implementing at least one exemplary embodiment. It should therefore likewise be acknowledged that the function and the arrangement of the components described with reference to an exemplary embodiment can be changed in different ways without thereby deviating from the scope of protection of the following claims, as well as the equivalents of the following claims.

1. (canceled)

2-15. (canceled)

16. A method for manufacturing a laminated panel comprising:
providing an unprocessed laminated panel having a first metal sheet, a second metal sheet and a plastic layer arranged between the first and second metal sheets;
locating a tool onto an outer side of at least one of the first and second metal sheets in a local connecting region;
locally heating at least one of the first and second metal sheets in the local connecting region by moving the tool relative to the outer side such that the plastic layer in the local connecting region is heated due to friction between the tool and the outer surface;
deforming at least one of the first and second metal sheets in the local connecting region to form a point of contact such that the heated plastic layer is displaced between the first and second metal sheets in the local connecting region; and
welding the first and the second metal sheet together at the point of contact, such that a welded joint is formed therebetween in the local connecting region.

17. The method according to claim 16, further comprising moving the tool relative to the outer is carried out in at least a rotatory motion on the outer side in order to generate friction between the tool and the outer side, wherein a rotational axis of the rotatory motion is in the local connecting region aligned.

18. The method according to claim 17, wherein the tool is located generally perpendicular to the outer side.

19. The method according to claim 16, further comprising moving the tool relative to the outer is carried out in at least a translatory motion on the outer side in order to generate friction between the tool and the outer side.

20. The method according to claim 16, further comprising lifting the tool off the metal sheet after the placement and the motion of the tool, and after the deformation of the metal sheet and displacement of the plastic layer.

21. The method according to claim 16, wherein the tool comprises a forming tool configured to apply a compressive force upon the outer side of the metal sheet in the local connecting region such that the metal sheet is deformed in the local connecting region and the heated plastic layer is displaced between the first and second metal sheets in the local connecting region.

22. The method according to claim 21, further comprising exerting the compressive force for the deformation of the metal sheet upon the metal sheet by the forming tool during the motion of the tool relative to the metal sheet in the local connecting region.

23. The method according to claim 21, further comprising exerting the compressive force for the deformation of the metal sheet upon the metal sheet by the forming tool after the motion of the tool relative to the metal sheet in the local connecting region.

24. The method according to claim 16, further comprising electric resistance welding the first and second metal sheets one another in the local connecting region.

25. The method according to claim 24, further comprising:
placing a first electrode onto the first metal sheet in the local connecting region;
placing a second electrode onto the second metal sheet in the local connecting region; and
subsequently directing a current through the first and the second electrode and through the first and the second metal sheet that are locally contacted with one another in the local connecting region.

26. The method according to claim 25, wherein the first and second electrodes are placed into contact with the first and second metal sheets respectively by a robotic actuator.

27. The method according to claim 16, wherein the first and second metal sheets and the plastic layer are heated, the first and second metal sheets are deformed, the plastic layer is displaced and the first and the second metal sheet are welded to one another in several local connecting regions to manufacture a laminated panel such that the first and the second metal sheet are connected to at welded joints in several local connecting regions.

28. The method according to claim 16, wherein the unprocessed laminated panel comprises first and second metal sheets selected from the group consisting of steel, aluminum or a combination thereof, and the plastic layer is selected from the group consisting of a polyethylene plastic, a polyamide plastic or a combination thereof.

29. A method for manufacturing an assembly comprising:
providing at least one unprocessed laminated panel;
manufacturing at least one laminated panel from the at least one unprocessed laminated panel according to claim 16;
providing a metal component; and
connecting the at least one laminated panel to the metal component to for a panel assembly.

30. The method according to claim 29, further comprising resistance welding the at least one laminate panel to the metal component.

31. The method according to claim 30, further comprising resistance welding the first and second metal sheets one another in the local connecting region such that the at least one laminate panel forms a welded connection to the metal component.

32. The method according to claim 30, further comprising forming a plurality of welded joints welding between the two metal sheets and the metal component in each local connecting region during the resistance welding.

33. The method according to claim 30, further comprising:
placing the first metal sheet in the local connecting region before the resistance welding operation is carried out;
placing the second metal sheet onto a first outer side of the metal component in the local connecting region; and
placing a second electrode onto the component on a second outer side in the local connecting region; and
conducting a current through the first and the second electrode, through the first and the second metal sheet and through the component that are locally contacted to one another in the local connecting region.

34. The method according to claim 30, further comprising welding the at least one laminated panel to the metal component in several local connecting regions.

35. The method according to one or more of claim 29, further comprising assembling a body structure for a motor vehicle having the panel assembly.
